(19) United States
(12) Patent Application Publication
(10) Pub. No.: US 2026/0010990 A1
(43) Pub. Date: Jan. 8, 2026

(54) ELECTRONIC APPARATUS, CONTROL METHOD, AND NON-TRANSITORY COMPUTER READABLE MEDIUM

(71) Applicant: CANON KABUSHIKI KAISHA, Tokyo (JP)

(72) Inventor: SUSUMU IGARASHI, Kanagawa (JP)

(21) Appl. No.: 19/250,640

(22) Filed: Jun. 26, 2025

(30) Foreign Application Priority Data
Jul. 4, 2024 (JP) 2024-107926

(51) Int. Cl. G06T 5/80; G06T 5/50

(52) U.S. Cl. CPC G06T 5/80; G06T 5/50; G06T 2207/20221

(57) ABSTRACT

An electronic apparatus according to the present disclosure includes a processor, and a memory storing a program which, when executed by the processor, causes the electronic apparatus to execute a conversion process of performing a geometric conversion process on a predetermined region in a first image that is an image in which an object is distorted, and execute a generation process of generating a display image that is an image to be displayed on a display, wherein in the generation process, the display image is generated on a basis of a second image based on the first image and an image subjected to the geometric conversion process and corresponding to the predetermined region.

### BACKGROUND

### Field of the Technology

The present disclosure relates to an electronic apparatus, and more particularly, relates to a method of confirming an image captured using a fisheye lens.

### Description of the Related Art

Since an image captured using a wide view angle lens such as a fisheye lens has a wide field of view, a reflection unintended by a photographer (for example, a reflection of a part of the photographer's body, a part of a tripod, or the like) is likely to occur as compared with an image captured using a normal lens. Therefore, the photographer needs to view the captured image to confirm whether an unintended reflection occurred.

An unintended reflection is likely to occur at an edge of the image. For example, while the photographer holds a camera, fingers are likely to be reflected on the edge of the image since the fingers are close to the vicinity of an edge of a lens. When the photographer leans forward, the photographer's head or a part of the photographer's hat is likely to be reflected at an upper edge the image, and when the camera is mounted on a tripod, a part of the tripod is likely to be reflected at a lower edge of the image.

An image captured using a fisheye lens (fisheye image) is distorted in a shape different from an actual appearance. To correct (reduce) such distortion, there is a method of cutting out a part of the fisheye image, performing a perspective projection conversion process on the part, and displaying the processed part. In the method, it is possible to display a region such as the vicinity of a center of the fisheye image including an object that the photographer wants to reflect (main object) without distortion, but a region to be displayed is limited to a part of the fisheye image. As described above, since unintended reflection is likely to occur at the edge of the image, a region where reflection is likely to occur is often not included in a region to be displayed. Therefore, a photographer (user) cannot confirm the entire image at once and cannot easily confirm whether unintended reflection occurred while confirming the main object.

Meanwhile, as a method of displaying an entire image at once, there are a method of displaying the fisheye image as it is and a method of converting the fisheye image into an equirectangular image by an equirectangular conversion process and displaying the converted image. Both the fisheye image and the equirectangular image are distorted in a shape different from an actual appearance. For example, in the fisheye image (circumferential fisheye format image), distortion increases as a distance from the center increases, and in the equirectangular image (equirectangular format image), distortion increases as a distance from the center in a vertical direction increases. As described above, since unintended reflection is likely to occur at the edge of the image, an unintendedly reflected target is likely to be displayed while largely distorted when the entire image is displayed at once. Therefore, a photographer (user) cannot easily ascertain what the object displayed at the edge of the image is (cannot easily determine whether the object is an unintendedly reflected target), and thus cannot easily confirm whether unintended reflection occurred.

Japanese Patent Laid-Open No. 2022-146970 discloses a technique for detecting a nearby object based on distance measurement information and displaying an item at a position of the nearby object.

However, in the technique of the related art disclosed in Japanese Patent Laid-Open No. 2022-146970, the item is merely displayed at the position of the detected nearby object, and the above-described problem when performing the perspective projection conversion process and the above-described problem when an entire image is displayed at once cannot be solved.

### SUMMARY

The present disclosure provides a technique that enables a user to easily confirm whether an unintended reflection occurred in an image in which an object is distorted.

An electronic apparatus according to the present disclosure includes a processor, and a memory storing a program which, when executed by the processor, causes the electronic apparatus to execute a conversion process of performing a geometric conversion process on a predetermined region in a first image that is an image in which an object is distorted, and execute a generation process of generating a display image that is an image to be displayed on a display, wherein in the generation process, the display image is generated on a basis of a second image based on the first image and an image subjected to the geometric conversion process and corresponding to the predetermined region.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an imaging apparatus according to a first embodiment.

FIG. 2 is a flowchart illustrating an overall process according to the first embodiment.

FIG. 3 is a schematic diagram illustrating an imaging unit according to the first embodiment.

FIG. 4A is a schematic diagram illustrating a developed image according to the first embodiment.

FIG. 4B is a schematic diagram illustrating a display image according to the first embodiment.

FIG. 5 is a flowchart illustrating a converted image generation process according to the first embodiment.

FIG. 6 is a flowchart illustrating a display image generation process according to the first embodiment.

FIG. 7A is a schematic diagram illustrating a developed image according to a second embodiment.

FIG. 7B is a schematic diagram illustrating a display image according to the second embodiment.

FIG. 8 is a flowchart illustrating a converted image generation process according to the second embodiment.

FIG. 9 is a flowchart illustrating a display image generation process according to the second embodiment.

FIG. 10 is a block diagram illustrating an imaging apparatus according to a third embodiment.

FIG. 11 is a flowchart illustrating an overall process according to the third embodiment.

FIG. 12A is a schematic diagram illustrating a developed image according to the third embodiment.

FIG. 12B is a schematic diagram illustrating an equirectangular image according to the third embodiment.

FIG. 12C is a schematic diagram illustrating a display image according to the third embodiment.

FIG. 13 is a flowchart illustrating a converted image generation process according to the third embodiment.

FIG. 14 is a flowchart illustrating a display image generation process according to the third embodiment.

FIG. 15 is a block diagram illustrating an imaging apparatus according to a fourth embodiment.

FIG. 16 is a flowchart illustrating an overall process according to the fourth embodiment.

FIG. 17 is a flowchart illustrating a display image generation process according to the fourth embodiment.

### DESCRIPTION OF THE EMBODIMENTS

### First Embodiment

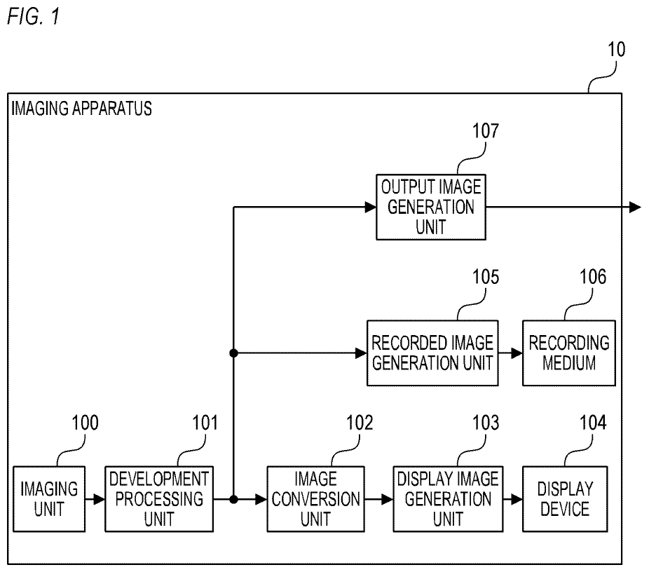

A first embodiment of the present disclosure will be described. FIG. 1 is a block diagram illustrating a configuration of an imaging apparatus 10 as an example of an electronic apparatus to which the present disclosure is applied. The imaging apparatus 10 includes an imaging unit 100, a development processing unit 101, an image conversion unit 102, a display image generation unit 103, a display device 104, a recorded image generation unit 105, a recording medium 106, and an output image generation unit 107.

A function of each unit of the imaging apparatus 10 may be realized by either software or hardware except for physical devices such as the imaging unit 100, the display device 104, and the recording medium 106. For example, the function of each unit may be realized by hardware such as a dedicated device, a logic circuit, or a memory. The function of each unit may be realized by a memory, a processing program stored in the memory, or a computer such as a CPU that executes the processing program.

The imaging apparatus 10 is, for example, a digital camera. The imaging apparatus 10 is not limited to the digital camera and may be, for example, a personal computer, a mobile phone, a smartphone, a PDA, a tablet terminal, a digital video camera, or the like.

The imaging unit 100 includes an optical system including a fisheye lens, and an image sensor. The imaging unit 100 performs photoelectric conversion of an optical image formed on the image sensor via the optical system, and performs A/D conversion of an obtained analog signal to generate (acquire) a digital image signal (RAW data). The imaging unit 100 outputs the digital image signal (RAW data) to the development processing unit 101. The optical system may be included in a lens unit that can be mounted on and dismounted from the imaging apparatus 10.

The development processing unit 101 generates developed image data by performing a development process on the digital image signal (RAW data) input from the imaging unit 100. The development process includes, for example, a color interpolation process called a debayer (demosaic) process, a color space conversion process, a noise suppression process, an optical distortion correction process, an enlargement or reduction process, and the like, and developed image data representing luminance and color difference such as YCbCr4:2:2 is generated. The development processing unit 101 outputs the developed image data to the image conversion unit 102, the recorded image generation unit 105, and the output image generation unit 107. Here, since the imaging unit 100 includes a fisheye lens, distortion of an object occurs in the developed image represented by the developed image data.

The image conversion unit 102 performs a geometric conversion process on each of a plurality of regions in the developed image input from the development processing unit 101 and generates a plurality of converted images (a plurality of images subjected to the geometric conversion process; a plurality of pieces of converted image data each corresponding to the plurality of regions). The image conversion unit 102 outputs the plurality of converted images (a plurality of pieces of converted image data) to the display image generation unit 103. The plurality of regions will be described below.

The display image generation unit 103 generates a display image (display image data), for example, by combining the plurality of converted images (the plurality of pieces of converted image data) input from the image conversion unit 102. The display image generation unit 103 performs, for example, image processing such as a gamma conversion process, a color space conversion process, an enlargement or reduction process, and a matching process with an I/F of the display device 104, in addition to composition. The display image generation unit 103 outputs the display image (display image data) to the display device 104.

The display device 104 is a display device (display unit) for confirming a live view video or a captured (recorded) image, and includes a liquid crystal panel. The display device 104 is, for example, an electronic viewfinder or a rear display. The display device 104 displays the display image output from the display image generation unit 103. The display device 104 may be an external device of the imaging apparatus 10.

The recorded image generation unit 105 generates recorded image data by performing a compression process on the developed image data input from the development processing unit 101. The recorded image generation unit 105 stores the recorded image data in the recording medium 106. For example, the recorded image generation unit 105 generates still image data in a JPEG format, an HEIF format, or the like, or generates moving image data in an MPEG-2 standard, an H.264 standard, an H.265 standard, or the like, as recorded image data by a compression process.

The recording medium 106 is a medium that records various types of images and information, and is, for example, a magnetic tape, an optical disc, a semiconductor memory, or the like. The recording medium 106 may be mounted on and dismounted from the imaging apparatus 10.

The output image generation unit 107 generates output image data by performing predetermined image processing on the developed image data input from the development processing unit 101. For example, the output image generation unit 107 performs image processing such as a gamma conversion process, a color space conversion process, an enlargement or reduction process, and a matching process with an external output I/F such as SDI or HDMI (registered trademark) on the developed image data. The output image generation unit 107 outputs the output image data to outside of the imaging apparatus 10 via the external output I/F.

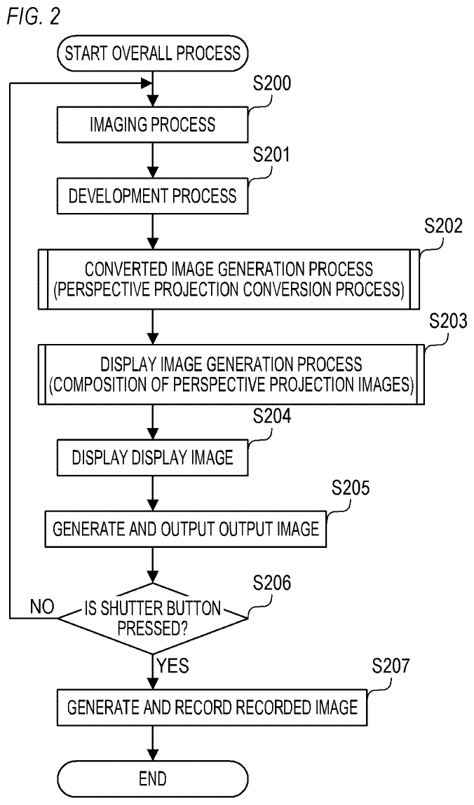

FIG. 2 is a flowchart of an overall process by the imaging apparatus 10. For example, when the imaging apparatus 10 starts, the overall process of FIG. 2 starts.

In step S200, the imaging unit 100 generates (acquires) a digital image signal (RAW data) by performing an imaging process. The imaging process includes the above-described photoelectric conversion and A/D conversion.

In step S201, the development processing unit 101 generates developed image data by performing a development process on the digital image signal obtained in step S200.

In step S202, the image conversion unit 102 generates a plurality of converted images (a plurality of pieces of converted image data) by performing a geometric conversion process on each of a plurality of regions in the developed image (developed image data) obtained in step S201.

In step S203, the display image generation unit 103 generates display image data, for example, by combining the plurality of pieces of converted image data obtained in step S202.

In step S204, the display device 104 displays the display image (display image data) obtained in step S203.

In step S205, the output image generation unit 107 generates output image data by performing predetermined image processing on the developed image data obtained in step S201, and outputs the output image data to outside. The process of step S205 can be performed after the process of step S201 is completed, and can be performed in parallel with the processes of steps S202 to S207.

In step S206, the imaging apparatus 10 (a computer (not illustrated) such as a CPU) determines whether a shutter button (not illustrated) is pressed by a user (for example, a photographer). When the imaging apparatus 10 determines that the shutter button is pressed, the process proceeds to step S207, and otherwise, the process proceeds to step S200.

In step S207, the recorded image generation unit 105 generates recorded image data by performing a compression process on the developed image data obtained in step S201, and stores the recorded image data in the recording medium 106.

The user can confirm the display image displayed on the display device 104, press the shutter button when the user determines that a desired display image is obtained, and record the desired display image on the recording medium 106.

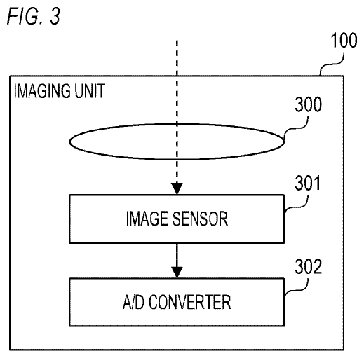

FIG. 3 is a schematic diagram illustrating a configuration of the imaging unit 100. The imaging unit 100 includes a lens unit 300, an image sensor 301, and an A/D converter 302. The lens unit 300 is an optical system including a fisheye lens, and forms an object image (an optical image of an object) on the image sensor 301 via the fisheye lens. A field of view (viewing angle) of the object image is not particularly limited, and in the first embodiment, it is assumed that an object image having a field of view of 180 degrees is formed in all directions parallel to an imaging plane (horizontal, vertical, and diagonal directions, and the like). The image sensor 301 includes a plurality of elements that perform photoelectric conversion of incident light, and each element outputs a pixel signal (analog signal corresponding to one pixel) acquired by photoelectric conversion. The A/D converter 302 converts each of the plurality of pixel signals (the plurality of analog signals) output from the image sensor 301 into a digital signal, and outputs a digital image signal including the obtained plurality of digital signals.

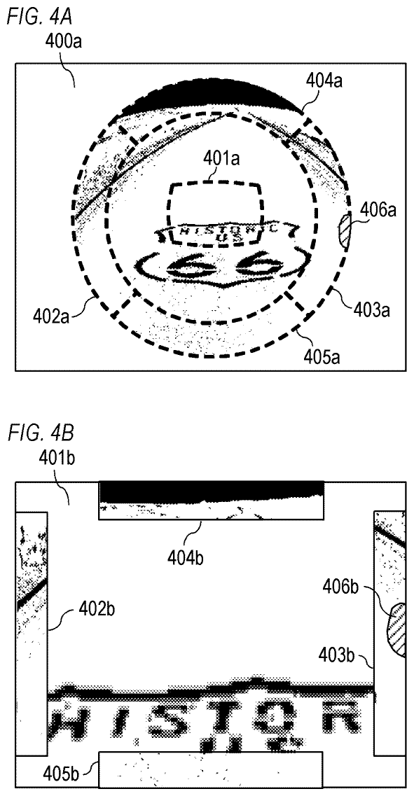

FIG. 4A is a schematic diagram illustrating an example of a developed image. The developed image in FIG. 4A includes a circular valid pixel region at the center. The valid pixel region is a region of the object image exposed and formed by the image sensor 301 and is a fisheye image region (for example, a circumferential fisheye image region). The developed image also includes an invalid pixel region 400a as a region outside of the valid pixel region. Since the invalid pixel region 400a is not exposed, for example, a monochromatic region or a region with a predetermined pattern is set as the invalid pixel region 400a. A fisheye image (for example, a circumferential fisheye image) of only the valid pixel region may be obtained as the developed image.

A main display region 401a is a main region displayed on the display device 104. In the fisheye image region (fisheye image), the object is distorted in a shape different from the actual appearance. Therefore, in the first embodiment, distortion is reduced by performing a perspective projection conversion process on the main display region 401a. However, the main display region 401a to be subjected to the perspective projection conversion process is limited to a part of the fisheye image region. The main display region 401a may be a predetermined region such as a central portion of the fisheye image region or may be a region (portion) designated by the user.

Reflection unintended by the photographer (for example, reflection of a part of the photographer's body, a part of a tripod, the photographer's accessory such as a hat, or the like) is likely to occur at an edge (edge portion) of the fisheye image region. Since distortion of the object is large at the edge of the fisheye image region, when the fisheye image region is displayed as it is, the user cannot easily ascertain what the object displayed at the edge is (cannot easily determine whether the object is an unintendedly reflected target). Therefore, in the first embodiment, four predetermined regions of a left edge 402a, a right edge 403a, an upper edge 404a, and a lower edge 405a are set as edges of the fisheye image region, and the perspective projection conversion process is also performed on the regions. In FIG. 4A, an unintended reflection occurs in a reflection region 406a of the right edge 403a. The reflection region 406a is, for example, a region of the photographer's finger. The region on which the perspective projection conversion process is performed may be a fixed region or may be designated by the user. The imaging apparatus 10 (a computer (not illustrated) such as a CPU) may set a region on which the perspective projection conversion process is performed based on the developed image, the lens unit 300 (lens unit), and the like. The number of regions on which the perspective projection conversion process is performed is not particularly limited, and may be more or less than four.

FIG. 4B is a schematic diagram illustrating an example of the display image. The display image in FIG. 4B is an image in which a left edge image 402b, a right edge image 403b, an upper edge image 404b, and a lower edge image 405b are superimposed on a main display image 401b.

The main display image 401b is an image generated by performing the perspective projection conversion process on the main display region 401a in FIG. 4A. The left edge image 402b is an image generated by performing the perspective projection conversion process on the left edge 402a in FIG. 4A. The right edge image 403b is an image generated by performing the perspective projection conversion process on the right edge 403a in FIG. 4A. The upper edge image 404b is an image generated by performing the perspective projection conversion process on the upper edge 404a of FIG. 4A. The lower edge image 405b is an image generated by performing the perspective projection conversion process on the lower edge 405a in FIG. 4A. By the perspective projection conversion process, a reflection region 406b in which distortion of the reflection region 406a in FIG. 4A is reduced is obtained. When the user views the reflection region 406b, the user can easily ascertain what the reflected object is (can determine whether the object is an unintendedly reflected target) as compared with when viewing the reflection region 406a.

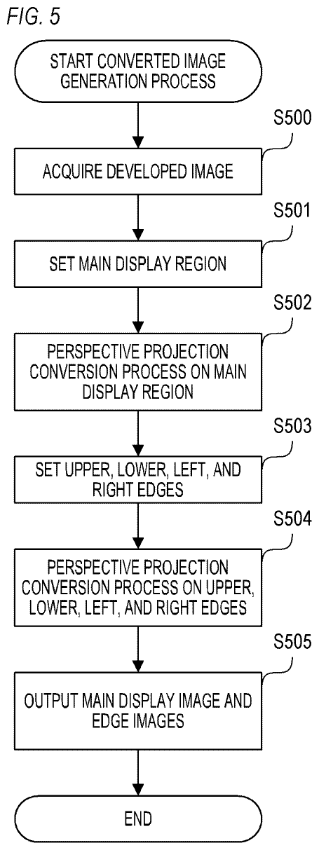

FIG. 5 is a flowchart illustrating a converted image generation process by the image conversion unit 102. The converted image generation process of FIG. 5 is performed, for example, in step S202 of FIG. 2.

In step S500, the image conversion unit 102 acquires a developed image that includes a fisheye image region from the development processing unit 101. For example, the developed image of FIG. 4A is acquired.

In step S501, the image conversion unit 102 sets a first region in the developed image acquired in step S500. For example, the main display region 401a in FIG. 4A is set as the first region.

In step S502, the image conversion unit 102 performs the perspective projection conversion process on the first region set in step S501. For example, the main display image 401b in FIG. 4B is generated by performing the perspective projection conversion process on the main display region 401a in FIG. 4A.

In step S503, the image conversion unit 102 sets a second region in the developed image acquired in step S500. For example, each of the left edge 402a, the right edge 403a, the upper edge 404a, and the lower edge 405a in FIG. 4A is set as the second region.

In step S504, the image conversion unit 102 performs the perspective projection conversion process on the second region set in step S503. For example, the perspective projection conversion process is performed on the left edge 402a, the right edge 403a, the upper edge 404a, and the lower edge 405a in FIG. 4A to generate the left edge image 402b, the right edge image 403b, the upper edge image 404b, and the lower edge image 405b in FIG. 4B.

In step S505, the image conversion unit 102 outputs the converted images generated in steps S502 and S504 to the display image generation unit 103. For example, the main display image 401b, the left edge image 402b, the right edge image 403b, the upper edge image 404b, and the lower edge image 405b in FIG. 4B are output.

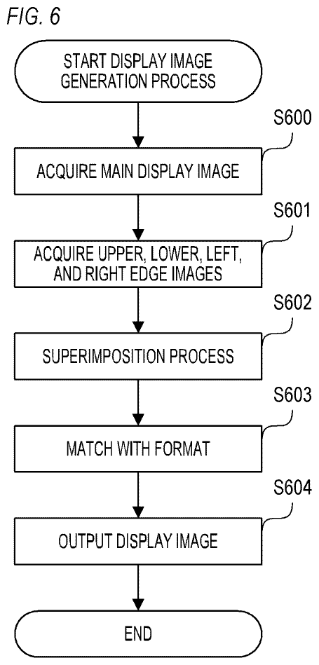

FIG. 6 is a flowchart illustrating a display image generation process by the display image generation unit 103. The display image generation process in FIG. 6 is performed, for example, in step S203 in FIG. 2.

In step S600, the display image generation unit 103 acquires a first region image as a converted image corresponding to the first region from the image conversion unit 102. For example, the main display image 401b of FIG. 4B is acquired.

In step S601, the display image generation unit 103 acquires a second region image as a converted image corresponding to the second region from the image conversion unit 102. For example, the left edge image 402b, the right edge image 403b, the upper edge image 404b, and the lower edge image 405b in FIG. 4B are acquired.

In step S602, the display image generation unit 103 performs a superimposition process of superimposing the second region image acquired in step S601 on the first region image acquired in step S600. For example, as illustrated in FIG. 4B, the left edge image 402b, the right edge image 403b, the upper edge image 404b, and the lower edge image 405b are superimposed on the main display image 401b. The left edge image 402b is superimposed on the left edge of the main display image 401b so that it is indicated that the left edge image 402b corresponds to the left edge 402a of the fisheye image region. Similarly, the right edge image 403b is superimposed on the right edge of the main display image 401b so that it is indicated that the right edge image 403b corresponds to the right edge 403a of the fisheye image region. The upper edge image 404b is superimposed on the upper edge of the main display image 401b so that it is indicated that the upper edge image 404b corresponds to the upper edge 404a of the fisheye image region. The lower edge image 405b is superimposed on the lower edge of the main display image 401b so that it is indicated that the lower edge image 405b corresponds to the lower edge 405a of the fisheye image region. The left edge image 402b, the right edge image 403b, the upper edge image 404b, and the lower edge image 405b may be combined to be adjacent to each edge of the main display image 401b instead of being superimposed on the main display image 401b. Here, the main display image 401b may be reduced. Regions where the left edge image 402b, the right edge image 403b, the upper edge image 404b, and the lower edge image 405b are to be combined may be cut out from the main display image 401b and then combined. The region to be cut out may be a region for one circumference of the main display image 401b.

In step S603, the display image generation unit 103 performs a process of matching the image obtained by the superimposition process of step S602 with an image format compatible with the display device 104. The matching process of step S603 includes, for example, a gamma conversion process, a color space conversion process, and an enlargement or reduction process.

In step S604, the display image generation unit 103 performs a process of matching the image obtained by the matching process of step S603 to an I/F of the display device 104, and outputs the image to the display device 104.

As described above, according to the first embodiment, the perspective projection conversion process is performed on the main display region that is a part of the fisheye image region (fisheye image) to generate the main display image, and the perspective projection conversion process is performed on the edges of the fisheye image region to generate the edge images. Then, the display image generation unit 103 generates a display image based on the main display image and the edge images. As such, the user can confirm the main display region while distortion of an object is removed (reduced). Similarly, the user can confirm the edges while distortion of the object is removed (reduced) (the user can easily ascertain details of the edges). As a result, the user can easily ascertain what the reflected object is, and can easily confirm whether an unintended reflection occurred.

The imaging apparatus 10 may have a plurality of operation modes in which display images are different as a plurality of settable operation modes. The plurality of operation modes may include an operation mode in which an image including a fisheye image region (for example, the developed image of FIG. 4A) is used as the display image without performing the perspective projection conversion process and the superimposition process. For example, the imaging apparatus 10 (a computer (not illustrated) such as a CPU) sets one of a plurality of operation modes in response to an instruction from a user.

### Second Embodiment

A second embodiment of the present disclosure will be described. Hereinafter, description of configurations and processes similar to those of the first embodiment will be omitted, and configurations and processes different from those of the first embodiment will be described. The second embodiment is different from the first embodiment in processes by the image conversion unit 102 and the display image generation unit 103.

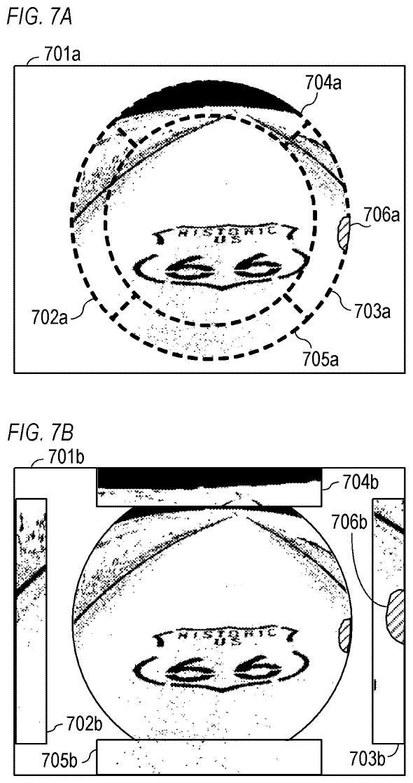

FIG. 7A is a schematic diagram illustrating an example of a developed image. As in FIG. 4A, a developed image 701a in FIG. 7A includes a circular valid pixel region (fisheye image region) at the center, and includes an invalid pixel region outside of the valid pixel region. In the second embodiment, as in the first embodiment, four predetermined regions of a left edge 702a, a right edge 703a, an upper edge 704a, and a lower edge 705a are set as edges of the fisheye image region, and the perspective projection conversion process is performed on the regions. However, unlike the first embodiment, the main display region is not set. In FIG. 7A, an unintended reflection occurs in a reflection region 706a of the right edge 703a.

FIG. 7B is a schematic diagram illustrating an example of the display image. The display image in FIG. 7B is an image in which a left edge image 702b, a right edge image 703b, an upper edge image 704b, and a lower edge image 705b are superimposed on a captured image 701b. The captured image 701b is an image similar to the developed image 701a in FIG. 7A. The left edge image 702b is an image generated by performing the perspective projection conversion process on the left edge 702a in FIG. 7A. The right edge image 703b is an image generated by performing the perspective projection conversion process on the right edge 703a in FIG. 7A. The upper edge image 704b is an image generated by performing the perspective projection conversion process on the upper edge 704a of FIG. 7A. The lower edge image 705b is an image generated by performing the perspective projection conversion process on the lower edge 705a in FIG. 7A. By the perspective projection conversion process, a reflection region 706b in which distortion of the reflection region 706a in FIG. 7A is reduced is obtained.

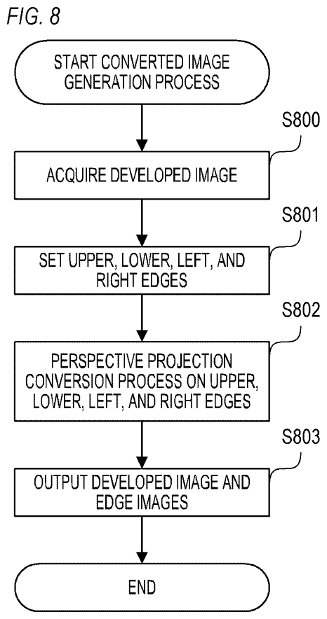

FIG. 8 is a flowchart illustrating a converted image generation process by the image conversion unit 102. The converted image generation process in FIG. 8 is performed, for example, in step S202 in FIG. 2.

In step S800, the image conversion unit 102 acquires a developed image that includes a fisheye image region from the development processing unit 101. For example, the developed image 701a in FIG. 7A is acquired.

In step S801, the image conversion unit 102 sets predetermined regions in the developed image acquired in step S800. For example, the left edge 702a, the right edge 703a, the upper edge 704a, and the lower edge 705a in FIG. 7A are set.

In step S802, the image conversion unit 102 performs the perspective projection conversion process on the predetermined regions set in step S801. For example, the perspective projection conversion process is performed on the left edge 702a, the right edge 703a, the upper edge 704a, and the lower edge 705a in FIG. 7A to generate the left edge image 702b, the right edge image 703b, the upper edge image 704b, and the lower edge image 705b in FIG. 7B.

In step S803, the image conversion unit 102 outputs the captured image (developed image) acquired in step S800 and the converted image generated in step S802 to the display image generation unit 103. For example, the captured image 701b, the left edge image 702b, the right edge image 703b, the upper edge image 704b, and the lower edge image 705b in FIG. 4B are output.

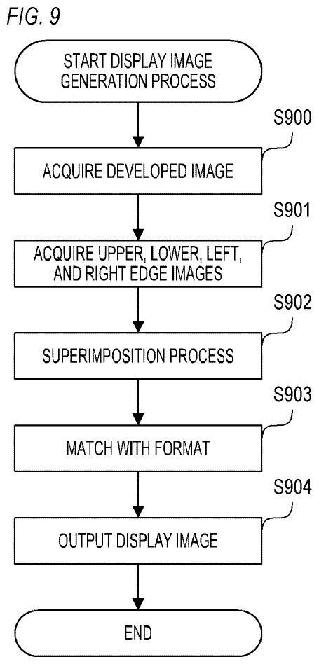

FIG. 9 is a flowchart illustrating a display image generation process by the display image generation unit 103. The display image generation process in FIG. 9 is performed, for example, in step S203 in FIG. 2.

In step S900, the display image generation unit 103 acquires the captured image (the developed image that includes a fisheye image region) from the image conversion unit 102. For example, the captured image 701b in FIG. 7B is acquired.

In step S901, the display image generation unit 103 acquires converted images corresponding to the predetermined regions from the image conversion unit 102. For example, the left edge image 702b, the right edge image 703b, the upper edge image 704b, and the lower edge image 705b in FIG. 7B are acquired.

In step S902, the display image generation unit 103 performs a superimposition process of superimposing the converted image acquired in step S901 on the captured image acquired in step S900. For example, as illustrated in FIG. 7B, the left edge image 702b, the right edge image 703b, the upper edge image 704b, and the lower edge image 705b are superimposed on the captured image 701b. The left edge image 702b is superimposed on a left edge of the captured image 701b, the right edge image 703b is superimposed on a right edge of the captured image 701b, the upper edge image 704b is superimposed on an upper edge of the captured image 701b, and the lower edge image 705b is superimposed on a lower edge of the captured image 701b.

In step S903, the display image generation unit 103 performs a process of matching the image obtained by the superimposition process in step S902 with an image format compatible with the display device 104. The matching process of step S903 includes, for example, a gamma conversion process, a color space conversion process, and an enlargement or reduction process.

In step S904, the display image generation unit 103 performs a process of matching the image obtained by the matching process of step S903 to the I/F of the display device 104, and outputs the image to the display device 104.

As described above, according to the second embodiment, the edge image is generated by performing the perspective projection conversion process on the edge of the fisheye image region. Then, a display image in which the edge image is superimposed on the captured image (developed image that includes a fisheye image region) is generated. As such, the user can easily confirm whether an unintended reflection occurred while confirming the entire fisheye image region.

In the second embodiment, similarly to the first embodiment, the imaging apparatus 10 may have a plurality of operation modes in which display images are different as a plurality of settable operation modes. The plurality of operation modes may include an operation mode in which an image that includes a fisheye image region (for example, the developed image 701a in FIG. 7A) is used as the display image without performing the perspective projection conversion process and the superimposition process.

### Third Embodiment

A third embodiment of the present disclosure will be described. Hereinafter, description of configurations and processes similar to those of the first embodiment will be omitted, and configurations and processes different from those of the first embodiment will be described.

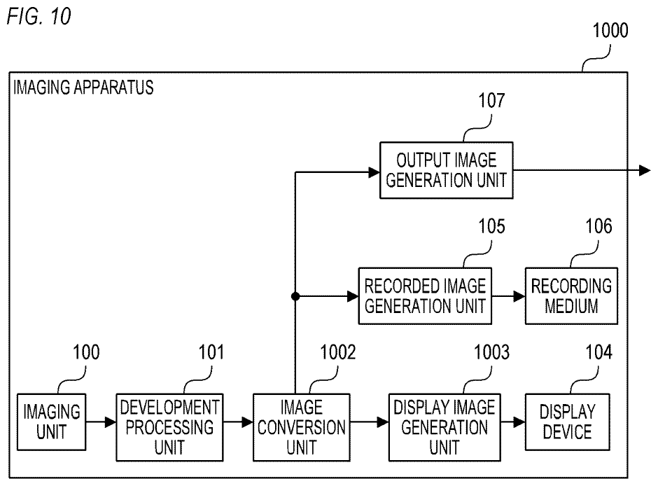

FIG. 10 is a block diagram illustrating a configuration of an imaging apparatus 1000 as an example of an electronic apparatus to which the present disclosure is applied. The imaging apparatus 1000 includes the imaging unit 100, the development processing unit 101, an image conversion unit 1002, a display image generation unit 1003, the display device 104, the recorded image generation unit 105, the recording medium 106, and the output image generation unit 107. Functions of the imaging unit 100, the development processing unit 101, the display device 104, the recorded image generation unit 105, the recording medium 106, and the output image generation unit 107 are similar to those of the first embodiment. However, the development processing unit 101 outputs the developed image to the image conversion unit 1002 without outputting the developed image to the recorded image generation unit 105 and the output image generation unit 107.

The image conversion unit 1002 generates an equirectangular image (equirectangular format image) by performing an equirectangular conversion process on the entire fisheye image region of the developed image input from the development processing unit 101. The image conversion unit 1002 outputs the equirectangular image to the display image generation unit 1003, the recorded image generation unit 105, and the output image generation unit 107. The image conversion unit 1002 may perform the equirectangular conversion process on a part of the fisheye image region.

The image conversion unit 1002 generates two perspective projection images (perspective projection format images) by performing the perspective projection conversion process on each of the upper edge and the lower edge of the equirectangular image. The image conversion unit 1002 outputs two perspective projection format images to the display image generation unit 1003. The number of regions on which the perspective projection conversion process is performed is not particularly limited, and may be one.

The display image generation unit 1003 generates a display image in which the perspective projection image is superimposed on the equirectangular image input from the image conversion unit 1002, and outputs the display image to the display device 104.

The functions of the recorded image generation unit 105 and the output image generation unit 107 are similar to those of Example 1, but the equirectangular image input from the image conversion unit 1002 is used instead of the developed image.

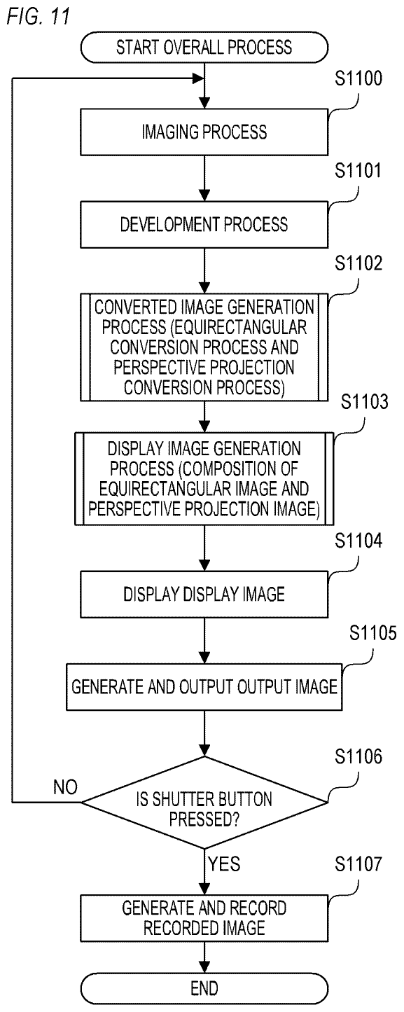

FIG. 11 is a flowchart illustrating an overall process by the imaging apparatus 1000. For example, when the imaging apparatus 1000 starts, the overall process of FIG. 11 starts.

In step S1100, the imaging unit 100 generates (acquires) a digital image signal (RAW data) by performing an imaging process.

In step S1101, the development processing unit 101 generates developed image data by performing a development process on the digital image signal obtained in step S1100.

In step S1102, the image conversion unit 1002 generates an equirectangular image (equirectangular image data) by performing an equirectangular conversion process on the entire fisheye image region of the developed image (developed image data) obtained in step S1101. The image conversion unit 1002 generates two perspective projection images (perspective projection image data) by performing the perspective projection conversion process on the upper edge and the lower edge of the equirectangular image.

In step S1103, the display image generation unit 1003 generates the display image data by superimposing the perspective projection image on the equirectangular image obtained in step S1102.

In step S1104, the display device 104 displays the display image (display image data) obtained in step S1103.

In step S1105, the output image generation unit 107 generates output image data by performing predetermined image processing on the equirectangular image data obtained in step S1102, and outputs the output image data to outside. The process of step S1105 can be performed after the process of step S1102 is completed, and can be performed in parallel with the processes of steps S1103 to S1107.

In step S1106, the imaging apparatus 1000 (a computer (not illustrated) such as a CPU) determines whether a shutter button (not illustrated) is pressed by a user (for example, a photographer). When the imaging apparatus 1000 determines that the shutter button is pressed, the process proceeds to step S1107, and otherwise, the process proceeds to step S1100.

In step S1107, the recorded image generation unit 105 generates recorded image data by performing a compression process on the equirectangular image data obtained in step S1102, and stores the recorded image data in the recording medium 106.

The user can confirm the display image displayed on the display device 104, press the shutter button when the user determines that a desired display image is obtained, and record the desired display image on the recording medium 106.

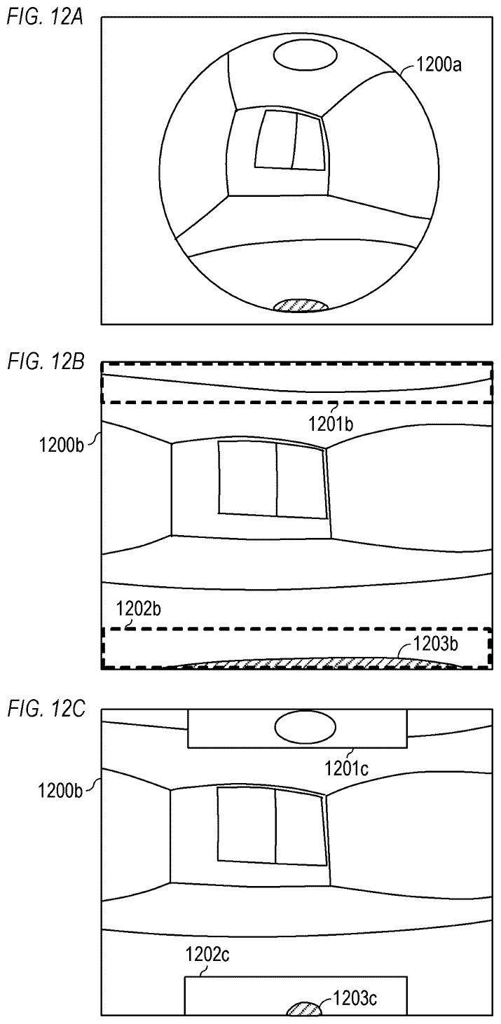

FIG. 12A is a schematic diagram illustrating an example of a developed image. As in FIG. 4A, the developed image in FIG. 12A includes a circular valid pixel region 1200a (fisheye image region) at the center, and includes an invalid pixel region outside of the valid pixel region. In the third embodiment, the entire fisheye image region is set, and the equirectangular conversion process is performed on the entire fisheye image region.

FIG. 12B is a schematic diagram illustrating an equirectangular image 1200b as an example of an equirectangular image generated by the equirectangular conversion process on the fisheye image region 1200a. By performing the equirectangular conversion process, it is possible to obtain an equirectangular image in which distortion of the object is smaller than that in the fisheye image region.

As described in the first embodiment, reflection unintended by the photographer (for example, reflection of a part of the photographer's body, a part of a tripod, the photographer's accessory such as a hat, or the like) is likely to occur at the edge of the fisheye image region. Distortion of the object is large at the upper edge and the lower edge (edges in the vertical direction) of the equirectangular image. Therefore, when the equirectangular image is displayed, the user cannot easily ascertain what the object displayed at the upper edge or the lower edge is (cannot easily determine whether the object is an unintendedly reflected target). Therefore, in the third embodiment, an upper edge 1201b and a lower edge 1202b of the equirectangular image 1200b are set, and the perspective projection conversion process is performed on the upper edge 1201b and the lower edge 1202b. In FIG. 12B, an unintended reflection occurs in the reflection region 1202b of the lower edge 1203b. The region on which the perspective projection conversion process is performed may be a fixed region or may be designated by the user. The imaging apparatus 1000 (a computer (not illustrated) such as a CPU) may set a region on which the perspective projection conversion process is performed based on the developed image, the equirectangular image, the lens unit 300 (lens unit), and the like.

FIG. 12C is a schematic diagram illustrating an example of a display image. The display image in FIG. 12C is an image in which an upper edge image 1201c and a lower edge image 1202c are superimposed on the equirectangular image 1200b. The upper edge image 1201c is an image generated by performing the perspective projection conversion process on the upper edge 1201b in FIG. 12B. The lower edge image 1202c is an image generated by performing the perspective projection conversion process on the lower edge 1202b in FIG. 12B. By the perspective projection conversion process, a reflection region 1203c in which distortion of the reflection region 1203b in FIG. 12B is reduced is obtained. When the user views the reflection region 1203c, the user can easily ascertain what the reflected object is (can determine whether the object is an unintendedly reflected target) as compared with when viewing the reflection region 1203b.

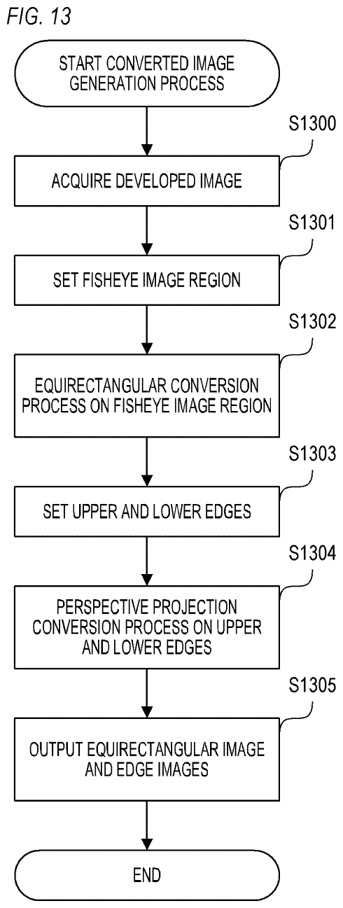

FIG. 13 is a flowchart illustrating a converted image generation process by the image conversion unit 1002. The converted image generation process in FIG. 13 is performed, for example, in step S1102 in FIG. 11.

In step S1300, the image conversion unit 1002 acquires a developed image that includes a fisheye image region from the development processing unit 101. For example, the developed image of FIG. 12A is acquired.

In step S1301, the image conversion unit 1002 sets a first region in the developed image acquired in step S1300. For example, the fisheye image region 1200a in FIG. 12A is set as the first region.

In step S1302, the image conversion unit 1002 performs the equirectangular conversion process on the first region set in step S1301. For example, the equirectangular image 1200b of FIG. 12B is generated by performing equirectangular conversion process on the fisheye image region 1200a of FIG. 12A.

In step S1303, the image conversion unit 1002 sets a second region in the equirectangular image generated in step S1301. For example, each of the upper edge 1201b and the lower edge 1202b in FIG. 12B is set as the second region.

In step S1304, the image conversion unit 1002 performs the perspective projection conversion process on the second region set in step S1303. For example, the perspective projection conversion process is performed on the upper edge 1201b and the lower edge 1202b of FIG. 12B to generate the upper edge image 1201c and the lower edge image 1202c of FIG. 12C.

In step S1305, the image conversion unit 1002 outputs the converted image generated in steps S1302 and S1304 to the display image generation unit 1003. For example, the equirectangular image 1200b in FIG. 12B, the upper edge image 1201c in FIG. 12C, and the lower edge image 1202c in FIG. 12C are output.

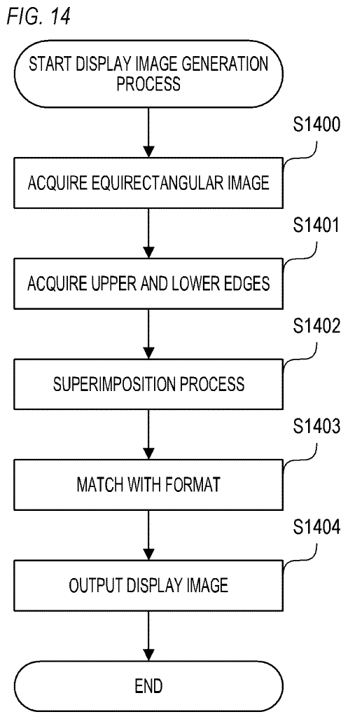

FIG. 14 is a flowchart illustrating a display image generation process by the display image generation unit 1003. The display image generation process in FIG. 14 is performed, for example, in step S1103 in FIG. 11.

In step S1400, the display image generation unit 1003 acquires a first region image as a converted image corresponding to the first region from the image conversion unit 1002. For example, the equirectangular image 1200b in FIG. 12B is acquired.

In step S1401, the display image generation unit 1003 acquires a second region image as a converted image corresponding to the second region from the image conversion unit 1002. For example, the upper edge image 1201c and the lower edge image 1202c in FIG. 12C are acquired.

In step S1402, the display image generation unit 1003 performs a superimposition process of superimposing the converted image acquired in step S1401 on the converted image acquired in step S1400. For example, as illustrated in FIG. 12C, the upper edge image 1201c and the lower edge image 1202c are superimposed on the equirectangular image 1200b. The upper edge image 1201c is superimposed on the upper edge of the equirectangular image 1200b, and the lower edge image 1202c is superimposed on the lower edge of the equirectangular image 1200b.

In step S1403, the display image generation unit 1003 performs a process of matching the image obtained by the superimposition process in step S1402 with an image format compatible with the display device 104. The matching process in step S1403 includes, for example, a gamma conversion process, a color space conversion process, and an enlargement or reduction process.

In step S1404, the display image generation unit 1003 performs a process of matching the image obtained by the matching process in step S1403 to the I/F of the display device 104, and outputs the image to the display device 104.

As described above, according to the third embodiment, the equirectangular image is generated by performing the equirectangular projection conversion process on the fisheye image region, and the edge image is generated by performing the perspective projection conversion process on the edge (the upper edge or the lower edge) of the equirectangular image. Then, a display image in which the edge image is superimposed on the equirectangular image is generated. As such, the user can easily confirm whether an unintended reflection occurred while confirming the entire fisheye image region in which distortion of the object is relatively small.

In the third embodiment, similarly to the first embodiment, the imaging apparatus 1000 may have a plurality of operation modes in which display images are different as a plurality of settable operation modes. The plurality of operation modes may include an operation mode in which the equirectangular image (for example, an equirectangular image 1200b in FIG. 12B) is used as the display image without performing the perspective projection conversion process or the superimposition process.

### Fourth Embodiment

A fourth embodiment of the present disclosure will be described. Hereinafter, description of configurations and processes similar to those of the first embodiment will be omitted, and configurations and processes different from those of the first embodiment will be described.

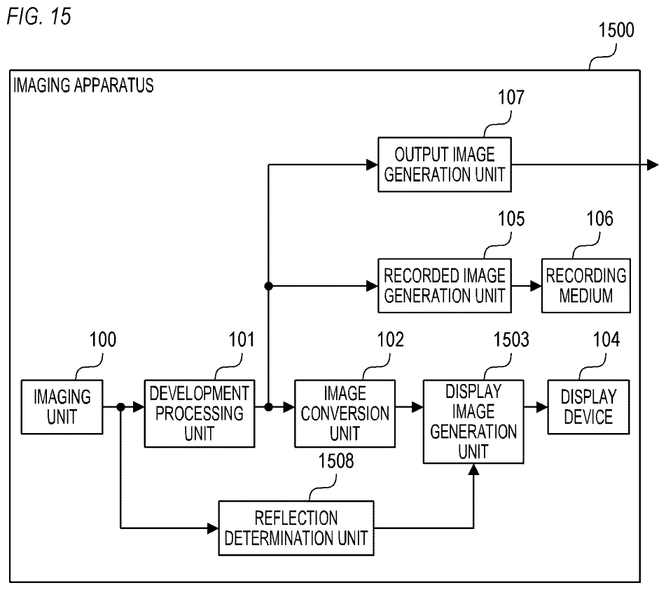

FIG. 15 is a block diagram illustrating a configuration of an imaging apparatus 1500 as an example of an electronic apparatus to which the present disclosure is applied. The imaging apparatus 1500 includes the imaging unit 100, the development processing unit 101, the image conversion unit 102, a display image generation unit 1503, the display device 104, the recorded image generation unit 105, the recording medium 106, the output image generation unit 107, and a reflection determination unit 1508. Functions of the imaging unit 100, the development processing unit 101, the image conversion unit 102, the display device 104, the recorded image generation unit 105, the recording medium 106, and the output image generation unit 107 are similar to those of the first embodiment. However, the imaging unit 100 outputs a digital image signal (RAW data) to the development processing unit 101 and the reflection determination unit 1508.

The reflection determination unit 1508 determines whether reflection of an object occurred at an edge (predetermined region) of a fisheye image region based on the digital image signal (RAW data) input from the imaging unit 100. The reflection determination unit 1508 outputs reflection information as a determination result of whether reflection occurred to the display image generation unit 1503. Determination of reflection may be interpreted as detection of reflection. A method of determining whether reflection occurred (detection method) is not particularly limited, and for example, whether reflection occurred may be determined based on developed image data generated by the development processing unit 101.

The display image generation unit 1503 generates a display image (display image data), for example, by combining a plurality of converted images (a plurality of pieces of converted image data) input from the image conversion unit 102 based on the reflection information input from the reflection determination unit 1508.

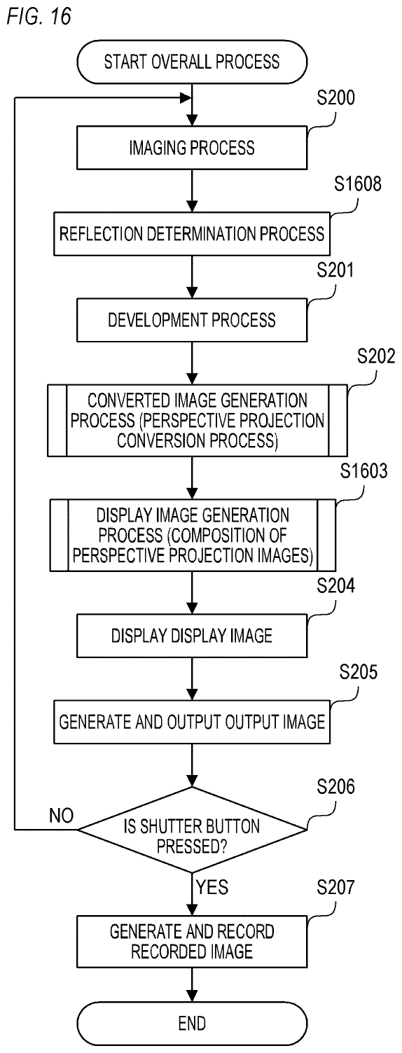

FIG. 16 is a flowchart illustrating an overall process by the imaging apparatus 1500. For example, when the imaging apparatus 1500 starts, the overall process of FIG. 16 starts. Steps S200 to S202 and S204 to S207 are as described in the first embodiment. In the overall process of FIG. 16, the process of step 1608 is performed between the process of step S200 and the process of step S201, and the process of step 1603 is performed between the process of step S202 and the process of step S204.

In step S1608, the reflection determination unit 1508 determines whether reflection of an object occurred at an edge of the fisheye image region based on the digital image signal obtained in step S200. The reflection determination unit 1508 outputs reflection information as a determination result of whether reflection occurred to the display image generation unit 1503. When it is determined that reflection occurred, the reflection determination unit 1508 outputs reflection information including position information of reflection to the display image generation unit 1503. The process of step S1608 can be performed after the process of step S200 is completed, and can be performed in parallel with the processes of steps S201 and S202.

In step S1603, the display image generation unit 1503 generates display image data, for example, by combining the plurality of pieces of converted image data obtained in step S202 based on the reflection information obtained in step S1608.

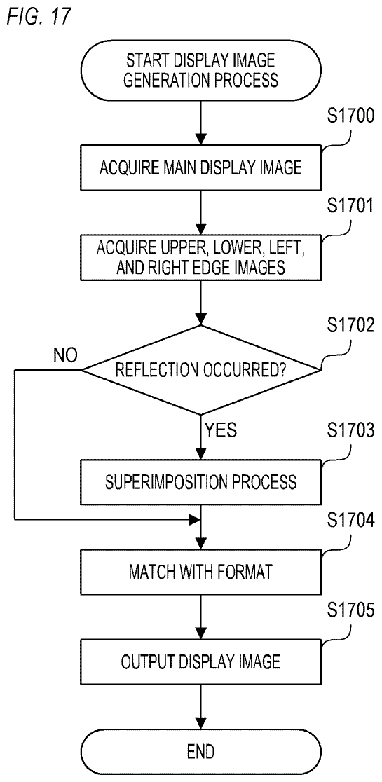

FIG. 17 is a flowchart illustrating a display image generation process by the display image generation unit 1503. The display image generation process in FIG. 17 is performed, for example, in step S1503 in FIG. 16.

In step S1700, the display image generation unit 1503 acquires a first region image as a converted image corresponding to the first region from the image conversion unit 102. For example, the main display image 401b of FIG. 4B is acquired.

In step S1701, the display image generation unit 1503 acquires a second region image as a converted image corresponding to the second region from the image conversion unit 102. For example, the left edge image 402b, the right edge image 403b, the upper edge image 404b, and the lower edge image 405b in FIG. 4B are acquired.

In step S1702, the display image generation unit 1503 determines whether reflection of an object occurred at an edge of the fisheye image region based on the reflection information input from the reflection determination unit 1508. When the display image generation unit 1503 determines that reflection occurred, the process proceeds to step S1703, and otherwise, the process proceeds to step S1704.

In step S1703, the display image generation unit 1503 performs a superimposition process of superimposing the second region image acquired in step S1701 on the first region image acquired in step S1700. For example, as illustrated in FIG. 4B, the left edge image 402b, the right edge image 403b, the upper edge image 404b, and the lower edge image 405b are superimposed on the main display image 401b.

In step S1704, the display image generation unit 1503 performs a process of matching the first region image (main display image) obtained in step S1701 or the image obtained by the superimposition process in step S1703 with an image format compatible with the display device 104. When it is determined in step S1702 that reflection did not occur, the matching process is performed on the first region image (main display image) obtained in step S1701. When it is determined in step S1702 that reflection occurred, the matching process is performed on the image obtained by the superimposition process in step S1703. The matching process in step S1704 includes, for example, a gamma conversion process, a color space conversion process, and an enlargement or reduction process.

In step S1705, the display image generation unit 1503 performs a process of matching the image obtained by the matching process in step S1704 to the I/F of the display device 104, and outputs the image to the display device 104.

As described above, according to the fourth embodiment, whether reflection occurred is determined, and the edge image is superimposed only when it is determined that reflection occurred (when reflection is detected). Accordingly, the same effects as those of the first embodiment can be obtained and unnecessary display of the edge image can also be prevented so that the main display image can be easily confirmed.

In the fourth embodiment, similarly to the first embodiment, the imaging apparatus 1500 may have a plurality of operation modes in which display images are different as a plurality of settable operation modes. The plurality of operation modes may include an operation mode in which an image including a fisheye image region (for example, the developed image of FIG. 4A) is used as the display image without performing the perspective projection conversion process and the superimposition process.

The display image generation unit 1503 may generate a display image in which a first graphic is superimposed when it is determined that reflection occurred, and may generate a display image in which a second graphic different from the first graphic is superimposed when it is determined reflection did not occur. As such, the user can more easily ascertain whether reflection occurred. For example, the first graphic is an icon, text, or the like indicating that reflection occurred, and the second graphic is an icon, text, or the like indicating that reflection did not occur.

The display image generation unit 1503 may superimpose only the edge image in which reflection occurred among the left edge image, the right edge image, the upper edge image, and the lower edge image on the main display image based on the reflection information. Based on the reflection information, the image conversion unit 102 may perform perspective projection conversion on only the edge where reflection occurred among the left edge, the right edge, the upper edge, and the lower edge of the fisheye image region. As such, it is possible to prevent unnecessary display of the edge image.

The display image generation unit 1503 may show the edge image in which reflection occurred to be identifiable with a thick frame or the like in the display image in which the left edge image, the right edge image, the upper edge image, and the lower edge image are superimposed on the main display image. As such, the user can easily ascertain the edge image in which reflection occurred.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

For example, the lens unit 300 of the imaging unit 100 may include two optical systems of which optical axis positions are different (two optical systems arranged side by side). Then, the lens unit 300 may form a left image and a right image having parallax with each other (two object images in which an object is distorted) on the image sensor 301 via the two optical systems. The image sensor 301 captures a left image and a right image. The image obtained by the image sensor 301 may be two images of a left image and a right image, or may be one image including an image region of the left image and an image region of the right image.

Here, the display image generation unit may generate a display image corresponding to one of the left image and the right image, or may generate a display image including an image region corresponding to the left image and an image region corresponding to the right image. The display image generation unit may switch the display image to be generated among the plurality of display images including the two display images in response to an instruction from the user.

Since there is parallax between the image region corresponding to the left image and the image region corresponding to the right image, reflection may occur in the right edge image corresponding to the right image even when reflection does not occur in the right edge image corresponding to the left image. Therefore, when the display image corresponding to the left image is generated, the right edge image corresponding to the right image may be combined instead of the right edge image corresponding to the left image. Similarly, when the display image corresponding to the right image is generated, the left edge image corresponding to the left image may be combined instead of the left edge image corresponding to the right image. Accordingly, it is also possible to confirm an unintended reflection in a non-display image of the left image and the right image having parallax with each other.

The display method may be changed so that the user can recognize that the right edge image corresponding to the right image is combined instead of the right edge image corresponding to the left image. For example, when the right edge image corresponding to the right image is combined instead of the right edge image corresponding to the left image, the right edge image corresponding to the right image may be highlighted with a thick frame.

The user may be able to designate a direction using a direction indication member or the like. Here, the image conversion unit may perform perspective projection conversion only on the edge in the direction designated by the user among the plurality of edges in the fisheye image region or the equirectangular image.

When the perspective projection conversion process for the edge is performed to display the edge image, depending on a display magnification, the entire edge image may not be capable of being displayed at once. The display image generation unit may generate a display image in which a part of the edge image (an image corresponding to a part of the edge (for example, a central portion)) is superimposed on the main display image or the like. Then, the display image generation unit may change a portion of the edge image to be superimposed on the main display image or the like (a portion of the edge image corresponding to the image to be superimposed on the main display image or the like) in response to an instruction from the user. For example, the display image generation unit may change (scroll) a portion of the edge image to be superimposed on the main display image or the like in a direction designated by the user.

The third and fourth embodiments may be combined so that the reflection determination unit 1508 determines whether reflection of an object occurred at the upper edge or the lower edge of the equirectangular image.

The image conversion unit may perform another geometric conversion process of reducing distortion of the object instead of the perspective projection conversion process and the equirectangular conversion process.

In the above-described embodiment, an example in which the present disclosure is applied to the imaging apparatus is described as an example, but the present disclosure is not limited to the example, and any electronic apparatus capable of performing image processing can be applied with the present disclosure. For example, the present disclosure can be applied to a personal computer, a PDA, a mobile phone terminal, a portable image viewer, a printer apparatus, a digital photo frame, a music player, a game machine, an electronic book reader, and the like. The present disclosure can be applied to a video player, a display apparatus (including a projection apparatus), a tablet terminal, a smartphone, an AI speaker, a home appliance, an in-vehicle apparatus, and the like.

The present disclosure can be applied not only to a main device of the imaging apparatus but also to a control device that communicates with an imaging apparatus (including a network camera) via wired or wireless communication to remotely control the imaging apparatus. Examples of an apparatus that remotely controls the imaging apparatus include devices such as a smartphone, a tablet PC, and a desktop PC. The imaging apparatus can be controlled remotely by notifying the imaging apparatus of a command from the control apparatus side that causes the apparatus to perform various operations and settings based on an operation performed on the control apparatus side or a process performed on the control apparatus side. A live view image captured by the imaging apparatus may be received via wired or wireless communication and may be displayed on the control device side.

When the present disclosure is applied to an electronic apparatus separated from the imaging apparatus, an image acquired from outside by the electronic apparatus may be a fisheye image or an equirectangular image. Although an example in which the present disclosure is applied to confirming a live view image is described, the present disclosure can also be applied to other various examples. For example, the present disclosure can also be applied to an example in which a plurality of images obtained by an imaging apparatus are stored in a storage medium, and the plurality of images are read from the storage medium and confirmed (an example of sequentially confirming a plurality of images and deleting an image in which unintended reflection occurred, and the like).

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

According to the present disclosure, a user can easily confirm whether an unintended reflection occurred in an image in which an object is distorted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-107926, filed Jul. 4, 2024, which is hereby incorporated by reference herein in its entirety.

What is claimed is:

1. An electronic apparatus comprising:
a processor; and
a memory storing a program which, when executed by the processor, causes the electronic apparatus to
execute a conversion process of performing a geometric conversion process on a predetermined region in a first image that is an image in which an object is distorted, and
execute a generation process of generating a display image that is an image to be displayed on a display,
wherein in the generation process, the display image is generated on a basis of a second image based on the first image and an image subjected to the geometric conversion process and corresponding to the predetermined region.

2. The electronic apparatus according to claim 1,
wherein the program, when executed by the processor, further causes the electronic apparatus to execute an acquisition process of acquiring a fisheye image that is the first image,
in the conversion process, a first conversion image corresponding to a first region is generated by performing the geometric conversion process on the first region in the fisheye image, and a second conversion image corresponding to a second region is generated by performing the geometric conversion process on the second region that is the predetermined region in the fisheye image, and
in the generation process, the display image is generated on a basis of the first conversion image and the second conversion image that are second images.

3. The electronic apparatus according to claim 2,
wherein the first region is a central portion of the fisheye image, and
the second region is an edge portion of the fisheye image.

4. The electronic apparatus according to claim 2,
wherein the first region is a portion designated by a user in the fisheye image, and
the second region is an edge portion of the fisheye image.

5. The electronic apparatus according to claim 1,
wherein the program, when executed by the processor, further causes the electronic apparatus to execute an acquisition process of acquiring an image that includes a fisheye image region,
in the conversion process, the geometric conversion process is performed on the predetermined region in the fisheye image region corresponding to the first image, and
in the generation process, the display image is generated on a basis of the image acquired by the acquisition process that is the second image and the image subjected to the geometric conversion process and corresponding to the predetermined region.

6. The electronic apparatus according to claim 5, wherein the predetermined region is an edge portion of the fisheye image region.

7. The electronic apparatus according to claim 1, wherein each of the first image and the second image is an identical equirectangular image.

8. The electronic apparatus according to claim 1,
wherein the program, when executed by the processor, further causes the electronic apparatus to execute an acquisition process of acquiring a fisheye image,
in the conversion process, a first conversion image that is the first image and is the second image is generated by performing a first geometric conversion process on the first region in the fisheye image, and a second conversion image corresponding to the predetermined region is generated by performing a second geometric conversion process on a second region that is the predetermined region in the first conversion image, and
in the generation process, the display image is generated on a basis of the first conversion image and the second conversion image.

9. The electronic apparatus according to claim 8,
wherein the first geometric conversion process is an equirectangular conversion process, and
the second geometric conversion process is a perspective projection conversion process.

10. The electronic apparatus according to claim 8,
wherein the first region is all of the fisheye image, and
the second region is an edge portion of the first conversion image in a vertical direction.

11. The electronic apparatus according to claim 1, wherein in the generation process, the display image is generated on a basis of the second image and the image subjected to the geometric conversion process only in a case where a predetermined operation mode is set.

12. The electronic apparatus according to claim 1,
wherein the program, when executed by the processor, further causes the electronic apparatus to execute a detection process of detecting reflection of an object in the predetermined region, and
in the generation process, the display image is generated further on a basis of whether or not the reflection is detected by the detection process.

13. The electronic apparatus according to claim 12, wherein in the generation process, the display image is generated on a basis of the second image and the image subjected to the geometric conversion process in a case where the reflection is detected by the detection process.

14. The electronic apparatus according to claim 12, wherein in the generation process, a display image on which a first graphic is superimposed is generated in a case where the reflection is detected by the detection process, and a display image on which a second graphic different from the first graphic is superimposed is generated in a case where the reflection is not detected by the detection process.

15. The electronic apparatus according to claim 1, wherein the predetermined region is an edge portion of the first image in a direction designated by a user.

16. The electronic apparatus according to claim 1,
wherein in the generation process,
the display image in which the second image and an image subjected to the geometric conversion process and corresponding to a part of the predetermined region are combined is generated, and
a portion of the predetermined region corresponding to the image subjected to the geometric conversion process to be combined with the second image is changed in response to an instruction from a user.

17. The electronic apparatus according to claim 1,
wherein two images captured by two optical systems arranged on left and right are acquired as images in which an object is distorted, and
in the generation process, switching between generation of a display image corresponding to one of the two optical systems and generation of a display image that includes two image regions respectively corresponding to the two optical systems is performed in response to an instruction from a user.

18. The electronic apparatus according to claim 1, wherein in the generation process, the display image in which the image subjected to the geometric conversion process and corresponding to the predetermined region is superimposed on the second image is generated.

19. A control method of an electronic apparatus, comprising:
performing a geometric conversion process on a predetermined region in a first image that is an image in which an object is distorted; and
generating a display image that is an image to be displayed on a display,
wherein the display image is generated on a basis of a second image based on the first image and an image subjected to the geometric conversion process and corresponding to the predetermined region.

20. A non-transitory computer readable medium that stores a program, wherein the program causes a computer to execute a control method of an electronic apparatus, comprising:
performing a geometric conversion process on a predetermined region in a first image that is an image in which an object is distorted; and
generating a display image that is an image to be displayed on a display,
wherein the display image is generated on a basis of a second image based on the first image and an image subjected to the geometric conversion process and corresponding to the predetermined region.
